(19) United States
(12) Patent Application Publication
(10) Pub. No.: US 2026/0298807 A1
(43) Pub. Date: Oct. 1, 2026

(54) Multiple Azimuth, Multiple Pass Optical Measurements Of Semiconductor Structures

(71) Applicant: KLA Corporation, Milpitas, CA (US)

(72) Inventors: Shankar Krishnan, Cupertino, CA (US); Phillip Atkins, San Jose, CA (US); YungChieh Chuang, Sunnyvale, CA (US); Houssam Chouaib, Milpitas, CA (US); Johannes D. de Veer, Menlo Park, CA (US)

(21) Appl. No.: 19/096,185

(22) Filed: Mar. 31, 2025

(51) Int. Cl. G01N 21/21; G01N 21/17; G01N 21/55; G01N 21/88; G01N 21/95

(52) U.S. Cl. CPC G01N 21/211; G01N 21/55; G01N 21/8806; G01N 21/9503; G01N 2021/1734; G01N 2021/213; G01N 2021/8835; G01N 2021/8848; G01N 2201/0636; G01N 2201/0683

(57) ABSTRACT

Methods and systems for performing multiple pass, multiple azimuth angle optical measurements of semiconductor structures are presented herein. The measurement beam interrogates the structure under measurement multiple times, each time at a different nominal azimuth angle as the measurement beam propagates from the illumination source to the detector. In some embodiments, each optical pass occurs at a different azimuth angle and a different angle of incidence. Multiple pass, multiple azimuth optical measurements amplify measurement sensitivity to critical parameters and break correlations between critical parameters that lead to undesirable measurement errors, excessive computational effort, or both. In some examples, values of one or more parameters of interest characterizing a structure under measurement are performed based on multiple pass, multiple azimuth angle measurement data, in combination with single pass measurement data, measurement data collected by another measurement subsystem, or any combination thereof.

### TECHNICAL FIELD

The described embodiments relate to metrology systems and methods, and more particularly to methods and systems for improved measurement of semiconductor structures.

### BACKGROUND INFORMATION

Semiconductor devices such as logic and memory devices are typically fabricated by a sequence of processing steps applied to a specimen. The various features and multiple structural levels of the semiconductor devices are formed by these processing steps. For example, lithography among others is one semiconductor fabrication process that involves generating a pattern on a semiconductor wafer. Additional examples of semiconductor fabrication processes include, but are not limited to, chemical-mechanical polishing, etch, deposition, and ion implantation. Multiple semiconductor devices may be fabricated on a single semiconductor wafer and then separated into individual semiconductor devices.

Metrology processes are used at various steps during a semiconductor manufacturing process to detect defects on wafers to promote higher yield. Optical metrology techniques offer the potential for high throughput without the risk of sample destruction. A number of optical metrology based techniques including scatterometry and reflectometry implementations and associated analysis algorithms are commonly used to characterize critical dimensions, film thicknesses, composition, overlay and other parameters of nanoscale structures.

As devices (e.g., logic and memory devices) move toward smaller nanometer-scale dimensions, characterization becomes more difficult. Devices incorporating complex three-dimensional geometry and materials with diverse physical properties contribute to characterization difficulty. In general, semiconductor device shapes and profiles are changing dramatically along with new process capabilities. In particular, advanced logic and memory devices must meet increasingly demanding specifications for Critical Dimension (CD) profiles. Thus, detailed features of geometric profiles must be measured accurately.

Significant advances in process chemistry have enabled new etch applications. In some examples, High Aspect Ratio (HAR) etch tools are capable of etching away very narrow vertical channels in semiconductor die with aspect ratios, i.e., ratio of height/width, of 80:1, or higher. This capability has enabled flash memory architectures to transition from two dimensional floating-gate architectures to fully three dimensional geometries. In some examples, film stacks and etched structures are very deep (e.g., three micrometers in depth, or more) and include an extremely high number of layers (e.g., 400 layers, or more).

As the etch process penetrates deeper into the structure, the etch rate is susceptible to change along the channel. This leads to a non-uniform etch profile, i.e., the Critical Dimension (CD) of a fabricated channel varies as a function of height. Typical semiconductor devices include millions of HAR channels separated from each other by extremely small distances, e.g., tens of nanometers. Thus, etch profile uniformity and parallelism of HAR channels must be controlled to very tight specifications to achieve an acceptable device yield.

High aspect ratio structures create challenges for film and CD measurements. The ability to measure the critical dimensions that define the shapes of holes and trenches of these structures is critical to achieve desired performance levels and device yield. The metrology must be capable of measuring the CD of a continuous profile through a deep channel to determine the location of CD variations and inflection points of profile variations.

In other examples, the most advanced memory and logic device structures, e.g., nanowire structures, forksheet structures, complementary field effect transistor (CFET) structures, multi-deck VNAND structures, etc., incorporate new complex three-dimensional geometry, dramatic topographic changes, and materials with diverse orientation and physical properties. These advanced devices are difficult to characterize.

In summary, measurement accuracy, precision, and stability are degraded due to low sensitivity to parameters of interest such as CD, shape, and film thickness, and high correlation among the parameters of interest. The problem is increasing in severity as logic and memory device features continue to scale to smaller and smaller dimensions.

X-ray based methods such as X-ray Photoemission Spectroscopy (XPS) and X-ray Fluorescence (XRF) perform atomic counts in thin films to determine thickness or composition. These measurements are slow, e.g., each measurement point requires multiple seconds, compared with optically based measurement techniques. Thus, many of the X-ray techniques are not applicable to high-volume measurement applications in a semiconductor manufacturing facility. Furthermore, some X-ray based measurement methods suffer from poor contrast, particularly in measurement applications where two or more layers include the same element, e.g., stacked layers of Titanium Nitride (TiN) and Titanium (Ti) of a Gate-All-Around (GAA) device, and stacked layers of Zirconium oxide and aluminum oxide of a DRAM capacitor device.

Existing high throughput optical metrology tools manufactured by KLA Corporation include the SpectraShape™ SS10k, SS11K, and SS12k tools focused on critical dimension and shape metrology, and SpectraFilm™ F1 and F10 tools focused on film metrology. Spectroscopic ellipsometry based measurement tools, such as the SpectraFilm™ F1 and SpectraFilm™ F10 tools, are employed to measure thickness and composition, e.g., thickness of high-K dielectric films and metal gate structures, dipole-doping layer composition, etc.

In general, a high throughput measurement system should be able to perform the desired measurement at a particular measurement site within one second, while maintaining measurement errors within desired limits, e.g., measurement uncertainty, accuracy, precision, and tool to tool matching. Unfortunately, measurement sensitivity to ultra-thin layers is limiting many measurement applications, and currently available high-throughput optical techniques are not able to meet cutting edge process requirements.

In an attempt to overcome measurement sensitivity limitations, measurement times are lengthened to increase signal to noise ratio by averaging. However, the negative impact on measurement throughput is undesirable. In some other examples, multiple metrology targets are fabricated on a wafer and measured as part of a multi-azimuth measurement in an attempt to break correlations among parameters of interest. However, this approach increases the complexity of the structures fabricated on the wafer, uses valuable wafer area for metrology specific targets, and in many fabrication process steps, multiple, different targets are not available because the distinguishing features have yet to be fabricated.

In summary, ongoing reductions in feature size, increasing depths and layers of structural features, and increasing use of opaque material layers impose difficult requirements on optical metrology systems. Optical metrology systems must meet high precision and accuracy requirements for increasingly complex targets at high throughput to remain cost effective. In this context, existing optical techniques have emerged as critical, performance limiting issues in the design of optical metrology systems suitable for critical dimension structures and thin films. Thus, improved metrology systems and methods to overcome these limitations are desired.

### SUMMARY

Methods and systems for performing multiple pass, multiple azimuth angle optical measurements of semiconductor structures are presented herein. Optical measurements of semiconductor structures are performed based on measurement signal information detected after multiple optical passes of the structure under measurement with each pass at a different nominal azimuth angle. In this manner, the measurement beam interrogates the structure under measurement multiple times, each time at a different nominal azimuth angle as the measurement beam propagates from the illumination source to the detector.

Multiple pass, multiple azimuth optical measurements of semiconductor structures amplify measurement sensitivity to critical parameters, e.g., CDs, shapes, and film thicknesses, and helps to break correlations between critical parameters that lead to undesirable measurement errors, excessive computational effort, or both. The increased measurement sensitivity enables greater measurement accuracy, precision, and stability, reduced measurement error, faster measurement, smaller measurement box sizes, improved wafer navigation positioning accuracy and repeatability, improved tool to tool matching, and reduced measurement recipe development effort.

Multiple pass, multiple azimuth optical measurements of semiconductor structures may be incorporated into many different types of optical measurement systems employed in the semiconductor industry, including, but not limited to: spectroscopic ellipsometers, spectroscopic reflectometers, angle resolved reflectometers, single-wavelength ellipsometers, etc. Measurement signals amplified due to multiple optical passes include, but are not limited to: Mueller matrix signals, harmonic signals, reflectance signals, etc.

In a further aspect, a multiple pass, multiple azimuth angle measurement system includes a positioning subsystem mechanically fixed to an optical element in the optical path between the illumination source and a detector of the measurement system. The positioning subsystem selectively positions the optical element in and out of the optical path of the measurement light scattered from the measurement site in response to illumination from the illumination source. When the optical element is positioned in the optical path of the measurement beam, the measurement beam is incident on the one or more structures under measurement multiple times, i.e., multiple pass measurement. When the optical element is positioned out of the optical path of the measurement beam, the measurement beam is incident on the one or more structures under measurement one time, i.e., single pass measurement.

In some examples, values of one or more parameters of interest characterizing a structure under measurement are performed based on both single pass measurement data and multiple pass, multiple azimuth angle measurement data.

In preferred embodiments, a multiple pass, multiple azimuth angle measurement system includes two spectrometers positioned to capture light scattered from a measurement site at two different azimuth angles. In these embodiments, the number of optical elements in the optical path between the illumination source and each spectrometer is minimized. However, in some other embodiments, a multiple pass, multiple azimuth angle measurement system includes one spectrometer positioned to capture light scattered from a measurement site at two different azimuth angles.

In a further aspect, a multi-pass, multi-azimuth measurement model estimates values of one or more parameters of interest based on measurement signals associated with multiple pass, multiple azimuth angle measurements of a primary target in combination with measurement signals associated with one or more single pass measurements of the primary target in any number of different single pass configurations, one or more measurements of the primary target by any number of different measurement techniques in any number of different configurations, or any combination thereof.

In some embodiments, illumination light is incident at a measurement site in multiple passes, each pass at a different azimuth angle and a different angle of incidence.

In some other embodiments, illumination light is incident at a measurement site in multiple passes, each pass at a different azimuth angle and the same angle of incidence.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 depicts an embodiment of a metrology system for performing broadband spectroscopic measurements of semiconductor structures with multiple optical passes, each at different azimuth angles, as described herein.

FIG. 2 depicts an embodiment 180 of a combined illumination source.

FIG. 3 is a diagram illustrative of a multi-pass, multi-azimuth angle measurement model in one embodiment.

FIG. 4 depicts another embodiment of a metrology system for performing broadband spectroscopic measurements of semiconductor structures with multiple optical passes, each at different azimuth angles, as described herein.

FIG. 5 is a chart 150 illustrative of simulated measurement performance of metal gate CD structures for six different measurement scenarios.

FIG. 6 is a plot 155 illustrative of the percentage improvement in MCI scores, expected precision, and sensitivity of the MPMA measurement scenarios (MS4, MS5, and MS6) compared to the conventional single pass measurement scenario, MS1, for the measurement results illustrated in FIG. 5.

FIG. 7 is a chart 160 illustrative of simulated measurement performance of the height of a CD structure for the six different measurement scenarios described with reference to FIG. 5.

FIG. 8 is a plot 165 illustrative of the percentage improvement in MCI scores, expected precision, and sensitivity of the MPMA measurement scenarios (MS4, MS5, and MS6) compared to the conventional single pass measurement scenario, MS1, for the measurement results illustrated in FIG. 7.

FIG. 9 is a chart 170 illustrative of simulated measurement performance of the height of a sidewall angle (SWA) of a CD structure for the six different measurement scenarios described with reference to FIG. 5.

FIG. 10 is a plot 175 illustrative of the percentage improvement in MCI scores, expected precision, and sensitivity of the MPMA measurement scenarios (MS4, MS5, and MS6) compared to the conventional single pass measurement scenario, MS1, for the measurement results illustrated in FIG. 9.

FIG. 11 illustrates a method 300 of performing measurements of semiconductor structures with multiple optical passes, each at different azimuth angles, as described herein.

### DETAILED DESCRIPTION

Reference will now be made in detail to background examples and some embodiments of the invention, examples of which are illustrated in the accompanying drawings.

Methods and systems for performing multiple pass, multiple azimuth angle optical measurements of semiconductor structures are presented herein. Conventional optical measurements of semiconductor structures are performed with one optical pass of the structure under measurement, i.e., the measurement beam interrogates the structure under measurement only once at a particular nominal azimuth angle in its path from the illumination source to the detector.

In one aspect, the optical subsystem of a semiconductor measurement system is configured such that the measurement beam is incident on the surface of the semiconductor wafer more than once in an optical path between the illumination source and the detector. Furthermore, each incidence of the measurement beam on the surface occurs at a different azimuth angle. In preferred embodiments, the measurement beam traversing an optical path between the illumination source and the detector is incident multiple times at the same measurement site on the semiconductor wafer, and each incidence occurs at a different azimuth angle.

Multiple pass, multiple azimuth optical measurements of semiconductor structures amplify measurement sensitivity to critical parameters, e.g., CDs, shapes, and film thicknesses, and helps to break correlations between critical parameters that lead to undesirable measurement errors, excessive computational effort, or both. To first approximation, each optical ray defined as a unique wavelength and angle of incidence is incident on the same nominal structure of interest multiple times each at different azimuth angles. At each different measurement pass and azimuth angle, new signal information adds coherently with the prior signal information encoded in the optical ray. Thus, the amplification of the measurement signal is proportional to the square of the number of passes. For example, a multiple pass, multiple azimuth angle optical measurement that interrogates the same instance of a structure under measurement two times may increase measurement sensitivity by a factor of four.

In general, amplified measurement signal sensitivity induced by multiple pass, multiple azimuth measurements enables greater measurement accuracy, precision, and stability, reduced measurement error, and faster measurement. In addition, amplified measurement signal sensitivity induced by multiple pass, multiple azimuth measurements enables smaller measurement box sizes, improved wafer navigation positioning accuracy and repeatability, and improved tool to tool matching compared to single pass measurements. Furthermore, measurement recipe development effort is reduced using amplified measurement signals induced by multiple pass, multiple azimuth measurements. This enables the exploration of more process and device variations, which enables more robust and production worthy measurements.

In some embodiments, multiple pass, multiple azimuth measurements are employed in semiconductor process development and production metrology of shape features, film thicknesses, material composition, material bandgap measurements, or other property changes in real time. For example, multiple pass, multiple azimuth measurements may be employed to monitor atomic layer growth in semiconductor processes, material quantity or property changes induced by chemical or biologic reactions, etc.

Multiple pass, multiple azimuth measurements of a wide range of structures are contemplated within the scope of this patent document, including, but not limited to: FinFET devices including cFET devices, Gate-all-around (GAA) nanosheet and nanowire devices, including structures at all transistor formation processes, including nanosheet formation, SiGe recess, Inner spacer formation, and epitaxial growth steps, logic/foundry devices fabricated in accordance with High-K and Metal Gate (HKMG) processes, DRAM devices including High-K multi-layer stacks, e.g., Zirconium oxide and aluminum oxide multilayers, and any other future devices that have nanometer-scale feature sizes.

In some embodiments, multiple pass, multiple azimuth measurements improve measurement performance in many different measurement applications, including, but not limited to: 1) scatterometry critical dimension (SCD) measurements of logic devices at etch steps of 2 nanometer and 14 angstrom process nodes, and beyond, including GAA nanosheet and nanowire device transistor formation steps at the front-end-of-line and interconnect middle-end-of-line process steps; 2) SCD measurements of DRAM devices at the 10 nanometer process node, and beyond; 3) Logic lithography CD and Focus-Dose measurements on photo-resist patterning features; 4) recipe development for DRAM in-Die Overlay (IDO) and recipe Quality Metric (QM) to track measurement robustness; 5) High-K and Metal gate (HKMG) process monitoring and control during fabrication of Logic/Foundry GAA devices at 2 nanometer GAA fabrication nodes and beyond, including dipole doping layers having only one to two mono-atomic-layers; and 6) measurement of individual layer thicknesses and composition of multi-layer Si/SiGe superlattice structures of logic/foundry GAA devices.

Multiple pass, multiple azimuth optical measurements of semiconductor structures may be incorporated into many different types of optical measurement systems employed in the semiconductor industry, including, but not limited to: spectroscopic ellipsometers, spectroscopic reflectometers, angle resolved reflectometers, single-wavelength ellipsometers, etc. Measurement signals amplified due to multiple optical passes include, but are not limited to: Mueller matrix signals, harmonic signals, reflectance signals, etc.

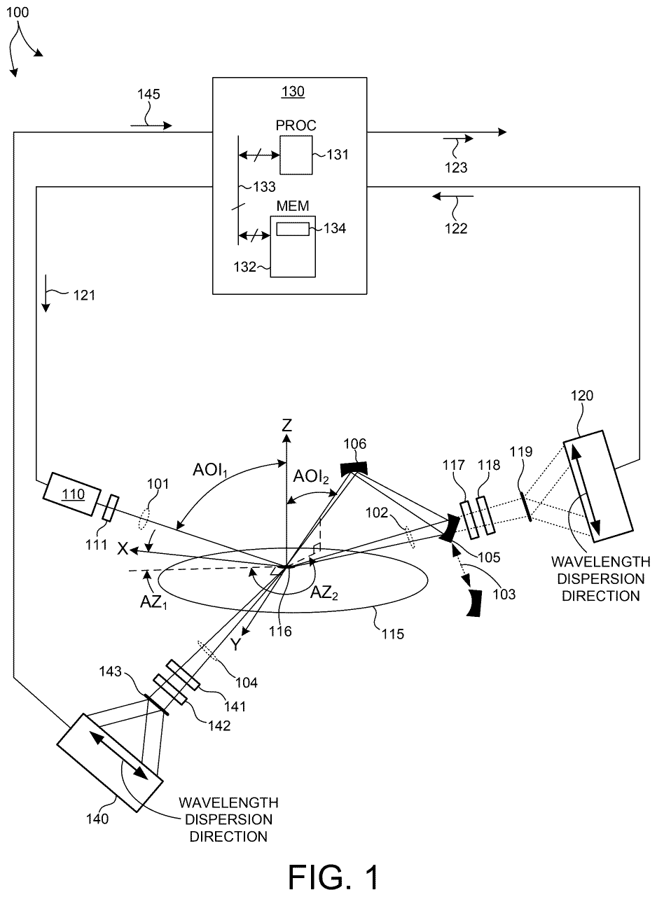

FIG. 1 depicts an exemplary, multiple pass, multiple azimuth metrology system 100 for performing broadband spectroscopic measurements of semiconductor structures (e.g., film thickness, critical dimensions, overlay, etc.). As depicted in FIG. 1, metrology system 100 is configured as an oblique incidence, broadband spectroscopic ellipsometer. However, in general, multiple pass, multiple azimuth metrology system 100 may also include additional spectroscopic ellipsometers, a spectroscopic reflectometer, scatterometer, or any combination thereof.

Metrology system 100 includes an illumination source 110 that generates a beam of illumination light 101 incident on a wafer 115. Illumination source 110 includes one or more illumination sources that emit illumination light including wavelengths in a range from 140 nanometers to 2,500 nanometers. In some examples, a single illumination source emits illumination light having wavelengths spanning a range from 170 nanometers to 900 nanometers. In some other examples, a laser sustained plasma light source emits illumination light having wavelengths spanning a range from 150 nanometers to 900 nanometers.

In some embodiments, illumination source 110 is a combined illumination source that emits illumination light in the ultraviolet, visible, and infrared spectra, including ultraviolet wavelengths down to 140 nanometers and infrared wavelengths greater than two micrometers, e.g., illumination wavelengths ranging from 140 nanometers to 2,500 nanometers. In some other embodiments, illumination source 110 is a combined illumination source that emits illumination light including wavelengths in a range from 140 nanometers to 7,000 nanometers.

In some embodiments, combined illumination source 110 includes a supercontinuum laser source and a laser sustained plasma light source. The supercontinuum laser source provides illumination at wavelengths greater than two micrometers, and in some embodiments, up to 5 micrometers, or more. The laser sustained plasma (LSP) light source (a.k.a., laser driven plasma source) produces photons spanning a wavelength range from 120 nanometers to 2500 nanometers, and beyond. The pump laser of the LSP light source may be continuous wave or pulsed. In some embodiments, combined illumination source 110 includes a supercontinuum laser source and an arc lamp, such as a Xenon arc lamp. However, a laser-driven plasma source produces significantly more photons than a Xenon lamp across the entire wavelength range from 120 nanometers to 2500 nanometers, and is therefore preferred.

In general, combined illumination source 110 includes a combination of a plurality of broadband or discrete wavelength light sources. The light generated by combined illumination source 110 includes a continuous spectrum or parts of a continuous spectrum, from ultraviolet to infrared (e.g., vacuum ultraviolet to long infrared). In general, combined illumination light source 110 may include a supercontinuum laser source, an infrared helium-neon laser source, a silicon carbide globar light source, a tungsten halogen light source, one or more infrared LEDs, one or more infrared lasers or any other suitable infrared light source generating wavelengths greater than two micrometers, and an arc lamp (e.g., a Xenon arc lamp), a deuterium lamp, a LSP light source, or any other suitable light source generating wavelengths less than two micrometers including visible and ultraviolet wavelengths.

In general, combined illumination source 110 includes multiple illumination sources optically coupled in any suitable manner. In some embodiments, light emitted by a supercontinuum laser source is directly coupled through the plasma generated by the ultraviolet/visible light source.

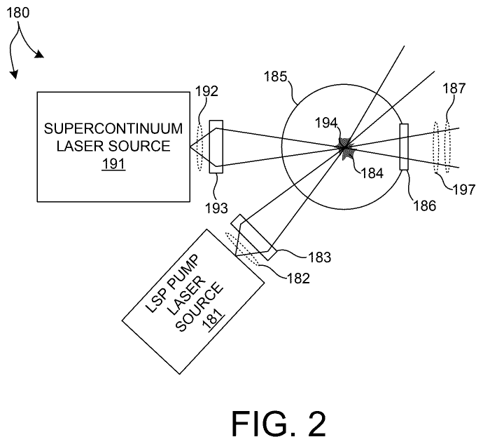

FIG. 2 depicts an embodiment 180 of a combined illumination source 110. As depicted in FIG. 2, a LSP pump laser source 181 generates pump light 182 that is focused by focusing optics 183 to sustain a plasma 184 contained by bulb 185. Plasma 184 generates broadband spectrum light over a wavelength range of ultra-violet to short infrared. Bulb 185 includes an exit port 186. LSP output light 187 is the portion of light from plasma 184 that passes through exit port 186 and is directed towards the illumination optics subsystem as described with reference to FIG. 1. In addition, supercontinuum laser source 191 generates infrared light 192 that is focused by focusing optics 193 to a focus 194 at or near plasma 184. Supercontinuum output light 197 is the portion of light from the focus 194 that passes through exit port 186 and is directed towards the illumination subsystem as described with reference to FIG. 1. In one example, the LSP output light 187 and supercontinuum output light 197 are co-located. In this manner, infrared light 197 from supercontinuum source 191 is effectively combined with ultraviolet/visible light 187 from LSP laser source 181. In one example, LSP output light 187 and supercontinuum output light 197 have the same or similar numerical aperture. In another example, LSP output light 187 and supercontinuum output light 197 have different numerical aperture. In some examples, bulb 185 is constructed from Calcium Fluoride or Magnesium Fluoride to transmit wavelengths above 2.5 micrometers generated by supercontinuum laser source 191. In some other examples, bulb 185 includes one or more exit ports 186 fabricated from Calcium Fluoride or Magnesium Fluoride to transmit wavelengths above 2.5 micrometers generated by supercontinuum laser source 191. A conventional bulb constructed from fused silica does not transmit significant light above 2.5 micrometers, and is thus unsuitable for combining light generated by the supercontinuum laser source 191 in the manner described herein. In some embodiments, the LSP pump laser source 181 is a continuous wave laser. In some other embodiments, the LSP pump laser source 181 is a pulsed laser.

As depicted in FIG. 1, metrology system 100 includes optical elements configured to direct a measurement beam incident on the surface of wafer 115 multiple times and at multiple azimuth angles in an optical path between illumination source 110 and detector 140. In the embodiment depicted in FIG. 1, reflective elements 105 and 106 are positioned in the optical path to direct light from measurement site 116 back to measurement site 116 in a second pass at a different azimuth angle.

As depicted in FIG. 1, metrology system 100 includes an illumination subsystem configured to direct illumination light 101 to one or more structures formed at measurement site 116 on wafer 115. The illumination subsystem may include any type and arrangement of optical filter(s), polarizing component, field stop, pupil stop, etc., known in the art of spectroscopic metrology. As depicted in FIG. 1, the illumination subsystem includes light source 110 and polarizing component 111. As depicted, in FIG. 1, the beam of illumination light 101 passes through polarizing component 111 as the beam propagates from the illumination source 110 to wafer 115. Beam 101 illuminates a portion of wafer 115 over a measurement site 116. In some embodiments, illumination light 101 is incident at wafer 115 in a first measurement pass at an angle of incidence, AOI₁, at or near 65 degrees from normal incidence, and azimuth angle, AZ₁. As depicted in FIG. 1, the XYZ coordinate system is fixed to wafer 115. The angles of incidence and azimuth angles depicted in FIG. 1 are referenced with respect to the XYZ coordinate frame, i.e., wafer 115. In some embodiments, the XYZ coordinate frame is aligned with a grating vector characterizing repeated structural features of fabricated on wafer 115. In this manner, azimuth angle is referenced with respect to the grating vector. However, in general, an azimuth angle may be referenced to any suitable orientation with respect to wafer 115.

In addition, the illumination subsystem may include filters, masks, beam shaping optics, illumination pupils, apodizers, etc. For example, the illumination subsystem may include an illumination field stop (not shown) and one or more optical filters (not shown). The illumination field stop controls the field of view (FOV) of the illumination subsystem and may include any suitable commercially available field stop. The optical filters are employed to control light level, spectral output, or both, from the illumination subsystem. In some examples, one or more multi-zone filters are employed as optical filters.

In some examples, noise and polarization optimization are performed to improve the performance of illumination source 110. In some examples, depolarization is achieved by use of multimode fibers, a Hanle depolarizer, or an integration sphere. In some examples, the illumination source etendue is optimized by use of light guides, fibers, and other optical elements (e.g., lenses, curved mirrors, apodizers, etc.). In some examples, source coherence or coherence effects are mitigated by coherence breaking techniques, or are otherwise accounted for by modeling and simulation.

Polarizing component 111 generates the desired polarization state exiting the illumination subsystem. In some embodiments, the polarizing component includes a polarizer, a compensator, or both, and may include any suitable commercially available polarizing component. The polarizer, compensator, or both, can be fixed, rotatable to different fixed positions, or continuously rotatable. Although the illumination subsystem depicted in FIG. 1 includes one polarizing component, the illumination subsystem may include more than one polarizing component. In some embodiments, a polarizer of polarizing component 111 is a Magnesium Fluoride Rochon polarizer. In some embodiments, a compensator of polarizing component 111 includes a quartz waveplate, a Magnesium Fluoride waveplate, a Calcium Fluoride K-prism, a Calcium Fluoride double Fresnel rhomb, or any combination thereof. In some embodiments, a compensator of polarizing component 111 includes one or more waveplates. In some of these embodiments, a first waveplate includes a desired retardation over a first wavelength range and a second waveplate includes a desired retardation over the first wavelength range a second, different wavelength range, etc.

As depicted in FIG. 1, illumination beam 101 is incident on wafer 115 at measurement site 116. Illumination beam 101 physically interacts with one or more structures under measurement at measurement site 116. The reflected beam 102 includes changes in wavefront phase and amplitude characteristics induced by the physical interaction of the first measurement pass.

As depicted in FIG. 1, beam 102 is reflected by reflective element 105, then reflective element 106, and is incident at measurement site 116 in a second measurement pass at an angle of incidence, AOI₂, and azimuth angle, AZ₂. Beam 102 reflects from the reflective optical elements 105 and 106 with minimal distortion of the wavefront phase and amplitude characteristics of measurement beam 102. In this manner, the light incident at measurement site 116 during the second measurement pass is encoded with the approximately the same wavefront characteristics of the light collected from measurement site 116 at the first measurement pass.

In these embodiments, beam 102 physically interacts with the one or more structures under measurement at measurement site 116, again, but at a different azimuth angle. The reflected beam 104 includes changes in wavefront phase and amplitude characteristics induced by the physical interaction of the second measurement pass.

Metrology system 100 also includes a collection optics subsystem configured to collect light generated by the interaction between the one or more structures and the measurement beam and focus the collected light at or near a dispersive element, e.g., a spectrometer slit, of a spectrometer. The collection optics subsystem may include any type and arrangement of optical filter(s), polarizing component, field stop, pupil stop, etc., known in the art of spectroscopic metrology.

As depicted in FIG. 1, beam 104 passes through compensator 141 and analyzer 142 as beam 104 propagates from wafer 115 to dispersive element 143 of the spectrometer. As depicted in FIG. 1, the collection optics subsystem includes a polarizing component that analyzes the polarization state of the collected light. In some embodiments, the polarizing component includes an analyzer, a compensator, or both, and may include any suitable commercially available polarizing component. The analyzer, compensator, or both, can be fixed, rotatable to different fixed positions, or continuously rotatable. The collection subsystem depicted in FIG. 1 includes a compensator 141 and an analyzer 142. In general, a collection optics subsystem may include any number of polarizing elements.

In some embodiments, compensator 141 includes a quartz waveplate, a Magnesium Fluoride waveplate, a Calcium Fluoride K-prism, a Calcium Fluoride double Fresnel rhomb, or any combination thereof. In some embodiments, compensator 141 includes one or more waveplates. In some of these embodiments, a first waveplate includes a desired retardation over a first wavelength range and a second waveplate includes a desired retardation over the first wavelength range or a second, different wavelength range, etc. In some embodiments, analyzer 142 is a Magnesium Fluoride Rochon analyzer.

In the embodiment depicted in FIG. 1, a spectrometer subsystem includes dispersive element 143, and one or more optics having reflective focusing power (not shown). Dispersive element 143 is typically located at or near a pupil plane of the collection optics subsystem. Dispersive element 143 disperses the light into discrete wavelengths on the active surface of detector 140.

Dispersive element 143 is typically a diffraction grating or a dispersive prism. In some embodiments, dispersive element 143 includes one or more segments and each segment receives light from one or more corresponding apertures of a collection mask. In this manner, light dispersed by dispersive element 143 includes light corresponding to one or more discrete angles of incidence at the wafer. In some embodiments, dispersive element 143 is a planar diffraction grating. In some of these embodiments, the planar diffraction grating is segmented to split the pupil into segments each corresponding to a different set of discrete angles of incidence at the wafer. Further details regarding pupil splitting are described in U.S. Pat. No. 10,690,602 to KLA-Tencor Corporation, the content of which is incorporated herein by reference in its entirety.

As depicted in FIG. 1, detector 140 receives light collected from wafer 115 at one or more angles of incidence, multiple wavelengths, e.g., 140 nanometers to 2,500 nanometers, and one or more polarization states. In the embodiment depicted in FIG. 1, the collection optics subsystem directs light to detector 140 and the detector 140 generates output signals 145 responsive to light collected from the one or more structures under measurement. The dispersive element 143 linearly disperses diffracted light according to wavelength along one dimension of detector 140 (i.e., the wavelength dispersion direction noted in FIG. 1). Dispersive element 143 causes a spatial separation among different wavelengths of light projected onto the surface of detector 140. In this manner, light collected from measurement site 116 having a particular wavelength is projected onto detector 140 at a spatial location that is different from light collected from measurement site 116 having another, different wavelength.

Metrology system 100 also includes computing system 130 configured to receive detected signals 145 and determines an estimate 123 of a value of a parameter of interest of the measured structure(s) based at least in part on output signals 145.

In the aforementioned example, the measurement beam twice interacts with the one or more structures under measurement at measurement site 116 in two measurement passes. In this example, beam 104 includes wavefront phase and amplitude information associated with two interactions with the one or more structures under measurement.

In a further aspect, a multiple pass, multiple azimuth angle measurement system includes a positioning subsystem mechanically fixed to an optical element in the optical path between the illumination source and a detector of the measurement system. The positioning subsystem selectively positions the optical element in and out of the optical path of the measurement light scattered from the measurement site in response to illumination from the illumination source. When the optical element is positioned in the optical path of the measurement beam, the measurement beam is incident on the one or more structures under measurement multiple times, i.e., multiple pass measurement. When the optical element is positioned out of the optical path of the measurement beam, the measurement beam is incident on the one or more structures under measurement one time, i.e., single pass measurement.

In the embodiment depicted in FIG. 1, reflective element 105 is coupled to an actuator subsystem 103, e.g., a linear actuator. Actuator subsystem 103 is also coupled to metrology system 100 and selectively moves reflective element 105 into the optical path of measurement beam 102 in one measurement scenario and out of the optical path of measurement beam 102 in another measurement scenario.

In one optical configuration, reflective optical element 105 is positioned in the optical path of measurement beam 102 by actuator subsystem 103. As depicted in FIG. 1, beam 102 is reflected by reflective element 105 and reflective element 106, and is incident at measurement spot 116 in a second measurement pass. In this example, the measurement beam twice interacts with the one or more structures under measurement at measurement site 116. In this example, beam 104 includes wavefront phase and amplitude information associated with two interactions with the one or more structures under measurement.

In another optical configuration, reflective optical element 105 is positioned out of the optical path of measurement beam 102 by actuator subsystem 103. In this this example, the measurement beam interacts once with the one or more structures under measurement at measurement site 116. In this configuration, beam 102 passes through compensator 117 and analyzer 118 as beam 102 propagates from wafer 115 to dispersive element 119, and ultimately detector 120 of the spectrometer (depicted as dashed lines in FIG. 1). Compensator 117, analyzer 118, dispersive element 119, and detector 120 are analogous to compensator 141, analyzer 142, dispersive element 143, and detector 140, respectively, as described hereinbefore. In the embodiment depicted in FIG. 1, the collection optics subsystem directs light to detector 120 and the detector 120 generates output signals 122 responsive to light collected from the one or more structures under measurement in a single measurement pass.

In this example, beam 102 includes wavefront phase and amplitude information associated with one interaction with the one or more structures under measurement as is the case in a conventional SE metrology subsystem. In some examples, single pass measurements may be convenient for purposes of calibration, baseline validation, data set diversity, etc.

In some examples, computing system 130 is also configured to receive detected signals 145 and 122 and determines an estimate 123 of a value of a parameter of interest of the measured structure(s) based at least in part on output signals 145 and 122, i.e., based on both single pass measurement data and multiple pass, multiple azimuth angle measurement data.

In the embodiment depicted in FIG. 1, metrology system 100 is easily configured to perform single pass and double pass measurements by simply controlling the position of reflective element 105 in or out of the measurement beam path. However, in general, other optical configurations may be contemplated to achieve both multiple pass measurements and single pass measurements.

In preferred embodiments, a multiple pass, multiple azimuth angle measurement system includes two spectrometers positioned to capture light scattered from a measurement site at two different azimuth angles. In these embodiments, the number of optical elements in the optical path between the illumination source and each spectrometer is minimized. However, in some other embodiments, a multiple pass, multiple azimuth angle measurement system includes one spectrometer positioned to capture light scattered from a measurement site at two different azimuth angles. In these embodiments, appropriate relay optics are required, for example, to relay both single pass measurement light and multiple pass measurement light to a single spectrometer. In general, these embodiments are not preferred due to optical losses inherent in optical configurations requiring significantly more optical elements and longer optical path.

Although, metrology system 100 is optically configured in a two-pass configuration at different azimuth angles, in general, metrology system 100 may be optically configured in an N-pass configuration, where N is any positive, integer number greater than one. For example, optical elements 105 and 106 may be replicated in the optical beam path of measurement beam 104 to redirect beam 104 back to measurement site 116 for a third pass at yet another, different azimuth angle.

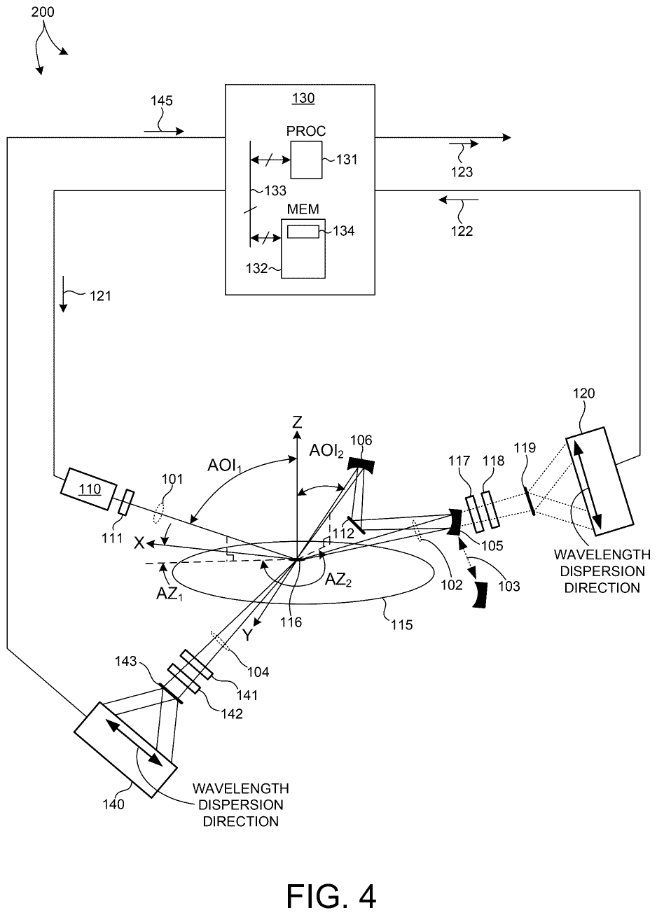

In general, all optical configurations to rotate the measurement beam by a fixed azimuth angle and return the measurement beam to the measurement site with approximately the same numerical aperture and approximately the same spot size are contemplated within the scope of this patent document. By way of non-limiting example, FIGS. 1 and 4 depict two different optical configurations to reorient the measurement beam.

In the embodiment depicted in FIG. 1, reflective optical elements 105 and 106 include reflective surfaces having parabolic shape. In preferred embodiments, reflective optical elements 105 and 106 include reflective surfaces having off-axis parabolic (OAP) shape. In these embodiments, all axial rays are in-plane, perpendicular to the back plane. In the embodiment depicted in FIG. 2, two reflective optical elements are employed to collect measurement beam 102 from measurement site 116 at an azimuth angle, AZ₁+180 degrees, and relay measurement beam 102 back to measurement site 116 at a different azimuth angle, AZ₂. For an angular difference, between AZ₂ and (AZ₁+180) of 40 degrees, the angles of incidence at the OAP reflective surfaces of reflective optical elements 105 and 106 are approximately 35 degrees.

Although, metrology system 100 includes two reflective elements to direct light from measurement site 116 back to measurement site 116 in a second pass, in general, any suitable arrangement including any number of reflective optical elements to direct light from measurement site 116 back to measurement site 116 may be contemplated within the scope of this patent document.

In some embodiments, a third reflective optical element is disposed in the optical path of the measurement beam as it propagates from the measurement site back to the measurement site for a subsequent measurement pass.

FIG. 4 depicts an exemplary, multiple pass, multiple azimuth angle metrology system 200 for performing broadband spectroscopic measurements of semiconductor structures (e.g., film thickness, critical dimensions, overlay, etc.). Like numbered elements depicted in FIG. 4 are analogous to those described with reference to metrology system 100 described with reference to FIG. 1.

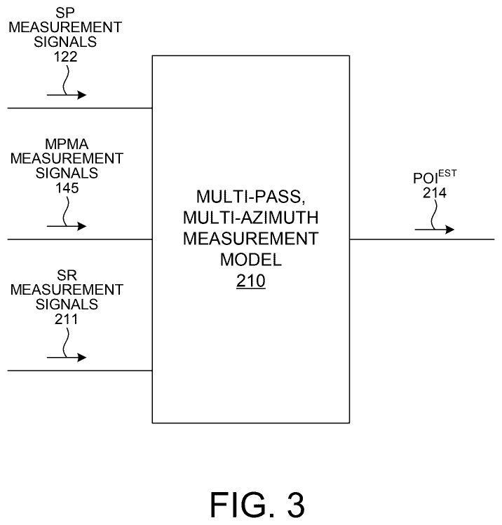

In the embodiment depicted in FIG. 3, a planar reflector 112 having a planar reflective surface is disposed in the optical path between reflective optical elements 105 and 106. Planar reflector 112 is directly or indirectly coupled to a frame that supports the other optical elements of metrology system 200. In the embodiment depicted in FIG. 4, the measurement beam reflects from planar reflector 112 with negligible change to the wavefront phase and amplitude characteristics of the measurement beam. In the embodiment depicted in FIG. 4, for the angular difference, between AZ₂ and (AZ₁+180) of 40 degrees, the angles of incidence at the OAP reflective surfaces of reflective optical elements 105 and 106 are approximately 8 degrees, and the angle of incidence at planar reflector 112 is approximately 35 degrees. In the embodiment depicted in FIG. 3, the angles of incidence at the OAP reflective surfaces of reflective optical elements 105 and 106 are significantly reduced compared to the embodiment depicted in FIG. 1. This may be advantageous to avoid distortion of wavefront phase and amplitude characteristics induced by the OAP reflective surfaces.

FIG. 3 is a diagram illustrative of a multi-pass, multi-azimuth angle measurement model 210 in one embodiment. As depicted in FIG. 3, multi-pass, multi-azimuth angle measurement model 210 receives measurement signals, e.g., spectral measurement signals 145 illustrated in FIG. 1, associated with a multiple pass, multiple azimuth angle measurement of one or more structures disposed one a semiconductor wafer. In some embodiments, multi-pass, multi-azimuth angle measurement model 210 estimates the values of one or more parameters of interest, POI_{EST} 214, based on measurement signals 145.

In some embodiments, multi-pass, multi-azimuth angle measurement model 210 also receives measurement signals 122 associated with one or more single pass measurements of the one or more structures, and multi-pass, multi-azimuth angle measurement model 210 estimates the values of one or more parameters of interest, POI_{EST} 214, based on measurement signals 145 and 122.

In some embodiments, multi-pass, multi-azimuth angle measurement model 210 also receives measurement signals 211 associated with measurements of the one or more structures by one or more different measurement techniques, and multi-pass, multi-azimuth angle measurement model 210 estimates the values of one or more parameters of interest, POI_{EST} 214, based on measurement signals 145 and 211.

In some other embodiments, multi-pass, multi-azimuth angle measurement model 210 estimates the values of one or more parameters of interest, POI_{EST} 214, based on measurement signals 145, 122, and 211.

In one example, measurement signals 145 are associated with a two pass measurement of one or more structures at measurement site 116 at different azimuth angles as depicted in FIG. 1, measurement signals 122 associated with a single pass measurement of the one or more structures at measurement site 116 as depicted in FIG. 1, and measurement signals 211 associated with measurement of the one or more structures at measurement site 116 by another metrology technique, e.g., spectroscopic reflectometry.

Although FIG. 3 depicts a multi-pass, multi-azimuth angle measurement model having signal inputs associated with three different measurement scenarios, any multi-pass, multi-azimuth angle measurement model having multiple pass, multiple azimuth angle measurement signal input, alone, or in combination with other measurement scenarios, is contemplated within this patent document.

In general, a multi-pass, multi-azimuth measurement model estimates values of one or more parameters of interest based on measurement signals associated with multiple pass, multiple azimuth angle measurements of a primary target together with measurement signals associated with one or more single pass measurements of the primary target in any number of different single pass configurations, one or more measurements of the primary target by any number of different measurement techniques in any number of different configurations, or any combination thereof.

In general, a difference between the nominal azimuth angle associated with the first measurement pass, e.g., AZ₁ depicted in FIG. 1, and the nominal azimuth angle associated with a subsequent measurement pass, e.g., AZ₂ depicted in FIG. 1, is at least one degree. However, in practice, measurement signal information with sufficiently high signal to noise ratio is often based on nominal azimuth angle differences of at least 10 degrees. In other words, multiple passes on a measurement target along the same optical incidence path, or approximately the same optical incidence path, result in undesireable light loss that is not easily compensated for by increased sensitivity. Similarly, multiple pass, multiple azimuth angle measurement signals detected by the same detector as single pass measurement signals also result in undesireable light loss that is not easily compensated for by increased sensitivity. Thus, in preferred embodiments, different detectors, each aligned with a different single pass or multiple pass, multiple azimuth angle measurement, are implemented.

In some embodiments, illumination light is incident at the measurement site at the first measurement pass at a first nominal angle of incidence, e.g., AOI₁ depicted in FIG. 1, and the measurement light incident at the measurement site at a subsequent measurement pass is incident at the measurement site a different nominal angle of incidence, e.g., AOI₂ depicted in FIG. 1. In some embodiments, the difference between the two different nominal angles of incidence is greater than 0.1 degrees.

However, in some other embodiments, the nominal angle of incidence of the illumination light incident at the measurement site at the first measurement pass is the same as the nominal angle of incidence of the measurement light incident at the measurement site at a subsequent measurement pass.

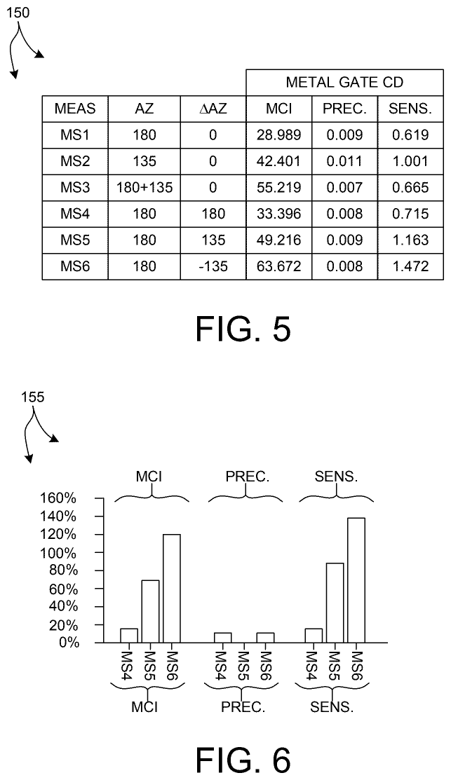

FIG. 5 is a chart 150 illustrative of simulated measurement performance of metal gate CD structures for six different measurement scenarios. Measurement performance is evaluated by three different measures: measurement capability index (MCI), expected measurement precision, and measurement sensitivity. The first measurement scenario (MS1) is a single pass measurement at a nominal azimuth angle of 180 degrees with respect to the grating vector. The second measurement scenario (MS2) is a single pass measurement at a nominal azimuth angle of 135 degrees with respect to the grating vector. The third measurement scenario (MS3) is a combined measurement scenario including the sum of measurement data sets associated with the first two measurement scenarios, i.e., two, independent single pass measurements at different nominal azimuth angles. The fourth measurement scenario (MS4) is a double pass measurement at a first pass azimuth angle of 180 degrees and a second pass azimuth angle at −180 degrees, i.e., the opposite direction. The fifth measurement scenario (MS5) is a double pass measurement at a first pass azimuth angle of 180 degrees and a second pass azimuth angle at 315 degrees. The sixth measurement scenario (MS6) is a double pass measurement at a first pass azimuth angle of 180 degrees and a second pass azimuth angle at 45 degrees. The fourth, fifth, and sixth measurement scenarios are examples of multiple pass, multiple azimuth angle measurement scenarios.

FIG. 6 is a plot 155 illustrative of the percentage improvement in MCI scores, expected precision, and sensitivity of the MPMA measurement scenarios (MS4, MS5, and MS6) compared to the conventional single pass measurement scenario, MS1, for the measurement results illustrated in FIG. 5. In general, the MPMA measurement scenarios, and in particular, the fifth and sixth measurement scenarios, exhibit significant improvement in MCI scores and measurement sensitivity compared to the conventional single pass measurement scenario.

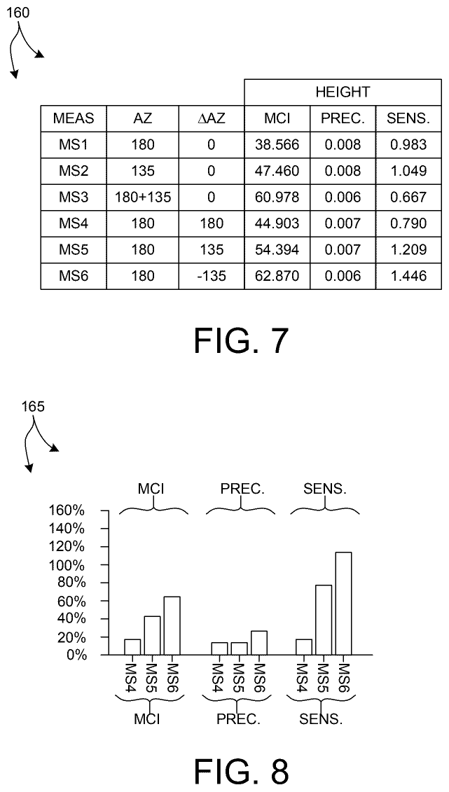

FIG. 7 is a chart 160 illustrative of simulated measurement performance of the height of a CD structure for the six different measurement scenarios described with reference to FIG. 5.

FIG. 8 is a plot 165 illustrative of the percentage improvement in MCI scores, expected precision, and sensitivity of the MPMA measurement scenarios (MS4, MS5, and MS6) compared to the conventional single pass measurement scenario, MS1, for the measurement results illustrated in FIG. 7. In general, the MPMA measurement scenarios, and in particular, the fifth and sixth measurement scenarios, exhibit significant improvement in MCI scores, expected precision, and measurement sensitivity compared to the conventional single pass measurement scenario.

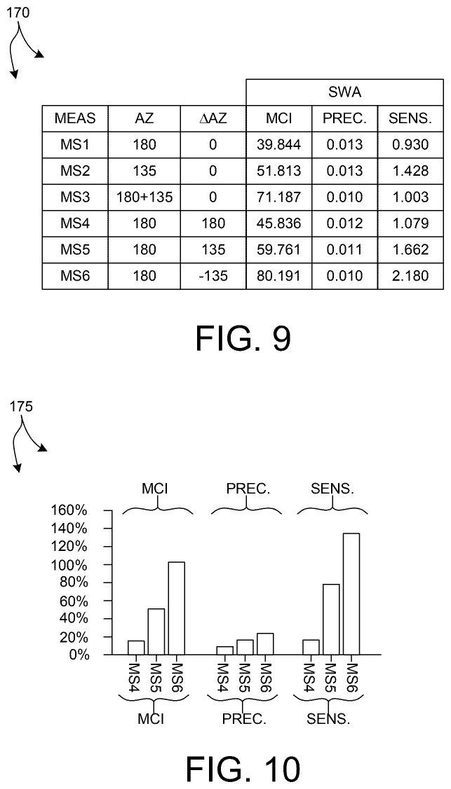

FIG. 9 is a chart 170 illustrative of simulated measurement performance of the height of a sidewall angle (SWA) of a CD structure for the six different measurement scenarios described with reference to FIG. 5.

FIG. 10 is a plot 175 illustrative of the percentage improvement in MCI scores, expected precision, and sensitivity of the MPMA measurement scenarios (MS4, MS5, and MS6) compared to the conventional single pass measurement scenario, MS1, for the measurement results illustrated in FIG. 9. In general, the MPMA measurement scenarios, and in particular, the fifth and sixth measurement scenarios, exhibit significant improvement in MCI scores, expected precision, and measurement sensitivity compared to the conventional single pass measurement scenario.

In general, as described hereinbefore, multiple pass, multiple azimuth angle measurements provide a product of the measurement results associated with each pass of the MPMA measurement. Furthermore, different azimuth angles increases data diversity and contributes to breaking of correlations in model based measurements. The combination of these two effects is a significant improvement over simply summing measurement data sets associated with single pass measurements at different azimuth angles, e.g., MS3.

In the embodiment depicted in FIG. 1, computing system 130 is configured to receive signals 145 indicative of the spectral response detected by the detector subsystem. Computing system 130 is further configured to determine control signals 121 that are communicated to programmable illumination source 110. Programmable illumination source 110 receives control signals 121 and adjusts the light output from illumination source 110 to achieve the desired illumination.

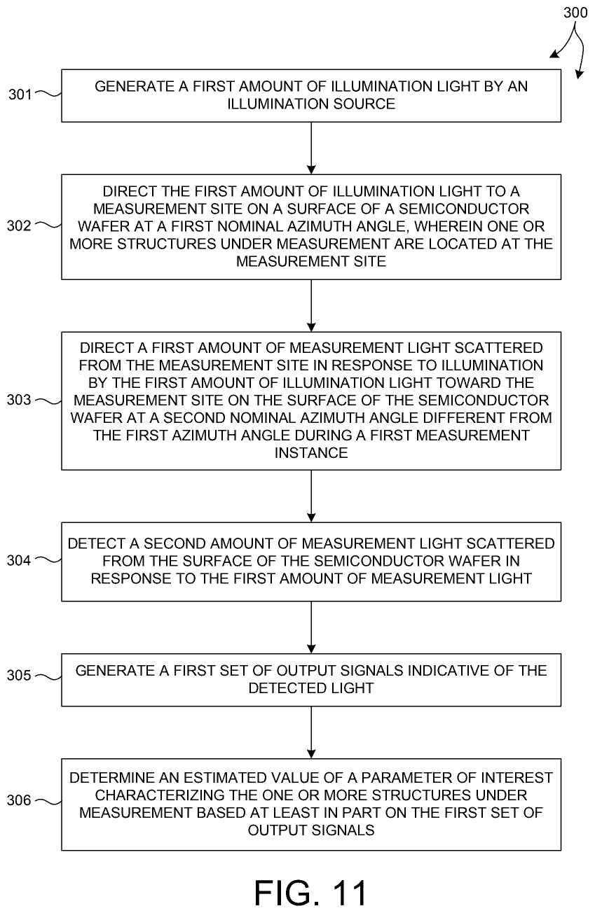

FIG. 11 illustrates a method 300 of performing spectroscopic measurements in at least one novel aspect. Method 300 is suitable for implementation by a metrology system such as metrology system 100 illustrated in FIG. 1 of the present invention. In one aspect, it is recognized that data processing blocks of method 300 may be carried out via a pre-programmed algorithm executed by one or more processors of computing system 130, or any other general purpose computing system. It is recognized herein that the particular structural aspects of metrology system 100 do not represent limitations and should be interpreted as illustrative only.

In block 301, a first amount of illumination light is generated by an illumination source.

In block 302, the first amount of illumination light is directed to a measurement site on a surface of a semiconductor wafer at a first nominal azimuth angle. One or more structures under measurement are located at the measurement site.

In block 303, a first amount of measurement light scattered from the measurement site in response to illumination by the first amount of illumination light is directed toward the measurement site on the surface of the semiconductor wafer at a second nominal azimuth angle different from the first azimuth angle during a first measurement instance.

In block 304, a second amount of measurement light is scattered from the surface of the semiconductor wafer in response to the first amount of measurement light.

In block 305, a first set of output signals indicative of the detected light is generated.

In block 306, an estimated value of a parameter of interest characterizing the one or more structures under measurement is determined based at least in part on the first set of output signals.

In a further embodiment, system 100 includes one or more computing systems 130 employed to perform measurements of actual device structures based on spectroscopic measurement data collected in accordance with the methods described herein. The one or more computing systems 130 may be communicatively coupled to the spectrometer. In one aspect, the one or more computing systems 130 are configured to receive measurement data associated with measurements of the structure of the specimen under measurement.

It should be recognized that one or more steps described throughout the present disclosure may be carried out by a single computer system 130 or, alternatively, a multiple computer system 130. Moreover, different subsystems of system 100 may include a computer system suitable for carrying out at least a portion of the steps described herein. Therefore, the aforementioned description should not be interpreted as a limitation on the present invention but merely an illustration.

In addition, the computer system 130 may be communicatively coupled to the spectrometers in any manner known in the art. For example, the one or more computing systems 130 may be coupled to computing systems associated with the spectrometers. In another example, the spectrometers may be controlled directly by a single computer system coupled to computer system 130.

The computer system 130 of metrology system 100 may be configured to receive and/or acquire data or information from the subsystems of the system (e.g., spectrometers and the like) by a transmission medium that may include wireline and/or wireless portions. In this manner, the transmission medium may serve as a data link between the computer system 130 and other subsystems of system 100.

Computer system 130 of metrology system 100 may be configured to receive and/or acquire data or information (e.g., measurement results, modeling inputs, modeling results, reference measurement results, etc.) from other systems by a transmission medium that may include wireline and/or wireless portions. In this manner, the transmission medium may serve as a data link between the computer system 130 and other systems (e.g., memory on-board metrology system 100, external memory, or other external systems). For example, the computing system 130 may be configured to receive measurement data from a storage medium (i.e., memory 132 or an external memory) via a data link. For instance, spectral results obtained using the spectrometers described herein may be stored in a permanent or semi-permanent memory device (e.g., memory 132 or an external memory). In this regard, the spectral results may be imported from on-board memory or from an external memory system. Moreover, the computer system 130 may send data to other systems via a transmission medium. For instance, a measurement model or an estimated parameter value 171 determined by computer system 130 may be communicated and stored in an external memory. In this regard, measurement results may be exported to another system.

Computing system 130 may include, but is not limited to, a personal computer system, mainframe computer system, workstation, image computer, parallel processor, or any other device known in the art. In general, the term “computing system” may be broadly defined to encompass any device having one or more processors, which execute instructions from a memory medium.

Program instructions 134 implementing methods such as those described herein may be transmitted over a transmission medium such as a wire, cable, or wireless transmission link. For example, as illustrated in FIG. 1, program instructions 134 stored in memory 132 are transmitted to processor 131 over bus 133. Program instructions 134 are stored in a computer readable medium (e.g., memory 132). Exemplary computer-readable media include read-only memory, a random access memory, a magnetic or optical disk, or a magnetic tape.

In some examples, the measurement models are implemented as an element of a SpectraShape® optical critical-dimension metrology system available from KLA-Tencor Corporation, Milpitas, California, USA. In this manner, the model is created and ready for use immediately after the spectra are collected by the system.

In some other examples, the measurement models are implemented off-line, for example, by a computing system implementing AcuShape® software available from KLA-Tencor Corporation, Milpitas, California, USA. The resulting, trained model may be incorporated as an element of an AcuShape® library that is accessible by a metrology system performing measurements.

In another aspect, the methods and systems for spectroscopic metrology of semiconductor devices described herein are applied to the measurement of high aspect ratio (HAR) structures, large lateral dimension structures, or both. The described embodiments enable optical critical dimension (CD), film, and composition metrology for semiconductor devices including three dimensional NAND structures, such as vertical-NAND (V-NAND) structures, dynamic random access memory structures (DRAM), etc., manufactured by various semiconductor manufacturers such as Samsung Inc. (South Korea), SK Hynix Inc. (South Korea), Toshiba Corporation (Japan), and Micron Technology, Inc. (United States), etc. These complex devices suffer from low light penetration into the structure(s) being measured. A spectroscopic ellipsometer with broadband capability and wide ranges of AOI, azimuth angle, or both, having simultaneous spectral band detection as described herein is suitable for measurements of these high-aspect ratio structures. HAR structures often include hard mask layers to facilitate etch processes for HARs. As described herein, the term “HAR structure” refers to any structure characterized by an aspect ratio that exceeds 2:1 or 10:1, and may be as high as 100:1, or higher.

In yet another aspect, the measurement results described herein can be used to provide active feedback to a process tool (e.g., lithography tool, etch tool, deposition tool, etc.). For example, values of measured parameters determined based on measurement methods described herein can be communicated to a lithography tool to adjust the lithography system to achieve a desired output. In a similar way etch parameters (e.g., etch time, diffusivity, etc.) or deposition parameters (e.g., time, concentration, etc.) may be included in a measurement model to provide active feedback to etch tools or deposition tools, respectively. In some example, corrections to process parameters determined based on measured device parameter values and a trained measurement model may be communicated to a lithography tool, etch tool, or deposition tool.

The optical systems described herein, e.g., measurement systems 100 and 200 depicted in FIGS. 1 and 4, respectively, are provided for purposes of illustration. In practice, many different optical arrangements may be contemplated within the scope of this patent document including various combinations of optical components, e.g., lens, filters, apertures, reflective elements, polarizers, etc., to achieve the desired optical properties of light incident at the wafer and the detector, e.g., wavelength, spot size, polarization, angle of incidence, azimuth angle, etc.

As described herein, the term “critical dimension” includes any critical dimension of a structure (e.g., bottom critical dimension, middle critical dimension, top critical dimension, sidewall angle, grating height, etc.), a critical dimension between any two or more structures (e.g., distance between two structures), and a displacement between two or more structures (e.g., overlay displacement between overlaying grating structures, etc.). Structures may include three dimensional structures, patterned structures, overlay structures, etc.

As described herein, the term “critical dimension application” or “critical dimension measurement application” includes any critical dimension measurement.

As described herein, the term “metrology system” includes any system employed at least in part to characterize a specimen in any aspect, including measurement applications such as critical dimension metrology, overlay metrology, focus/dosage metrology, and composition metrology. However, such terms of art do not limit the scope of the term “metrology system” as described herein. In addition, the metrology system 100 may be configured for measurement of patterned wafers and/or unpatterned wafers. The metrology system may be configured as a LED inspection tool, edge inspection tool, backside inspection tool, macro-inspection tool, or multi-mode inspection tool (involving data from one or more platforms simultaneously), and any other metrology or inspection tool that benefits from the calibration of system parameters based on critical dimension data.

Various embodiments are described herein for a semiconductor measurement system that may be used for measuring a specimen within any semiconductor processing tool (e.g., an inspection system or a lithography system). The term “specimen” is used herein to refer to a wafer, a reticle, or any other sample that may be processed (e.g., printed or inspected for defects) by means known in the art.

As used herein, the term “wafer” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a wafer may include only the substrate (i.e., bare wafer). Alternatively, a wafer may include one or more layers of different materials formed upon a substrate. One or more layers formed on a wafer may be “patterned” or “unpatterned.” For example, a wafer may include a plurality of dies having repeatable pattern features.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as amorphous SiO2. A reticle may be disposed above a resist-covered wafer during an exposure step of a lithography process such that the pattern on the reticle may be transferred to the resist.

One or more layers formed on a wafer may be patterned or unpatterned. For example, a wafer may include a plurality of dies, each having repeatable pattern features. Formation and processing of such layers of material may ultimately result in completed devices. Many different types of devices may be formed on a wafer, and the term wafer as used herein is intended to encompass a wafer on which any type of device known in the art is being fabricated.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A measurement system comprising:
an illumination source configured to generate a first amount of illumination light directed to a measurement site on a surface of a semiconductor wafer at a first nominal azimuth angle, wherein one or more structures under measurement are located at the measurement site;
a first reflective optical element located in an optical path of a first amount of measurement light scattered from the measurement site in response to illumination by the first amount of illumination light, the first amount of measurement light reflecting from a surface of the first reflective optical element;
a second reflective optical element located in an optical path of the first amount of measurement light reflected from the first reflective optical element, the first amount of measurement light reflecting from a surface of the second reflective optical element toward the measurement site on the surface of the semiconductor wafer at a second nominal azimuth angle different from the first azimuth angle; and
a first detector having a planar, two-dimensional surface sensitive to incident light, the first detector configured to detect a second amount of measurement light scattered from the surface of the semiconductor wafer in response to the first amount of measurement light and generate a first set of output signals indicative of the detected light;
a computing system configured to determine an estimated value of a parameter of interest characterizing the one or more structures under measurement based at least in part on the first set of output signals.

2. The measurement system of claim 1, wherein the first and second reflective optical elements include reflective surfaces having parabolic shape.

3. The measurement system of claim 1, further comprising:
a third reflective optical element disposed in the optical path of the first amount of measurement light reflected from the first reflective optical element, the first amount of measurement light reflecting from a surface of the third reflective optical element toward the second reflective optical element.

4. The measurement system of claim 1, further comprising:
a positioning subsystem mechanically fixed to the first reflective optical element, wherein the positioning subsystem selectively positions the first reflective optical element in and out of the optical path of the first amount of measurement light scattered from the measurement site in response to illumination by the first amount of illumination light.

5. The measurement system of claim 4, further comprising:
a second detector having a planar, two-dimensional surface sensitive to incident light, the second detector configured to detect the first amount of measurement light scattered from the surface of the semiconductor wafer when the positioning subsystem locates the first reflective element out of the optical path of the first amount of measurement light, the second detector configured to generate a second set of output signals indicative of the detected first amount of measurement light.

6. The measurement system of claim 5, wherein the computing system is configured to determine the estimated value of the parameter of interest characterizing the one or more structures under measurement based at least in part on the first and second sets of output signals.

7. The measurement system of claim 1, wherein the illumination source, the first and second reflective optical elements, and the first detector comprise a spectroscopic ellipsometer.

8. The measurement system of claim 7, wherein the computing system is configured to determine the estimated value of the parameter of interest characterizing the one or more structures under measurement based at least in part on the first set of output signals and a set of measurement signals generated by a second measurement subsystem different from the spectroscopic ellipsometer.

9. The measurement system of claim 8, wherein the second measurement subsystem is a spectroscopic reflectometer.

10. The measurement system of claim 7, the spectroscopic ellipsometer further comprising:
at least one rotating polarizing element located in an optical path of the first amount of illumination light between the illumination source and the measurement site; and
at least one rotating compensating element located in an optical path of the second amount of measurement light between the surface of the semiconductor wafer and the first detector.

11. The measurement system of claim 1, wherein a difference between the first nominal azimuth angle and the second nominal azimuth angle is at least one degree.

12. The measurement system of claim 1, wherein the first amount of illumination light is incident at the measurement site at a first nominal angle of incidence, and wherein the first amount of measurement light is incident at the measurement site at a second nominal angle of incidence.

13. The measurement system of claim 12, wherein a difference between the first and second nominal angles of incidence is greater than 0.1 degrees.

14. The measurement system of claim 12, wherein the first and second nominal angles of incidence are the same.

15. The measurement system of claim 1, wherein the one or more structures under measurement includes a critical dimension structure or a thin film structure.

16. A method comprising:
generating a first amount of illumination light by an illumination source;
directing the first amount of illumination light to a measurement site on a surface of a semiconductor wafer at a first nominal azimuth angle, wherein one or more structures under measurement are located at the measurement site;
directing a first amount of measurement light scattered from the measurement site in response to illumination by the first amount of illumination light toward the measurement site on the surface of the semiconductor wafer at a second nominal azimuth angle different from the first azimuth angle during a first measurement instance; and
detecting a second amount of measurement light scattered from the surface of the semiconductor wafer in response to the first amount of measurement light;
generating a first set of output signals indicative of the detected light; and
determining an estimated value of a parameter of interest characterizing the one or more structures under measurement based at least in part on the first set of output signals.

17. The method of claim 16, further comprising:
detecting the first amount of measurement light scattered from the surface of the semiconductor wafer during a second measurement instance; and
generating a second set of output signals indicative of the detected first amount of measurement light.

18. The method of claim 17, wherein the determining of the estimated value of the parameter of interest characterizing the one or more structures under measurement is based at least in part on the first and second sets of output signals.

19. The method of claim 16, wherein a difference between the first nominal azimuth angle and the second nominal azimuth angle is at least one degree.

20. A measurement system comprising:
an illumination source configured to generate a first amount of illumination light directed to a measurement site on a surface of a semiconductor wafer at a first nominal azimuth angle, wherein one or more structures under measurement are located at the measurement site;
a first reflective optical element located in an optical path of a first amount of measurement light scattered from the measurement site in response to illumination by the first amount of illumination light, the first amount of measurement light reflecting from a surface of the first reflective optical element;
a second reflective optical element located in an optical path of the first amount of measurement light reflected from the first reflective optical element, the first amount of measurement light reflecting from a surface of the second reflective optical element toward the measurement site on the surface of the semiconductor wafer at a second nominal azimuth angle different from the first azimuth angle;
a first detector having a planar, two-dimensional surface sensitive to incident light, the first detector configured to detect a second amount of measurement light scattered from the surface of the semiconductor wafer in response to the first amount of measurement light and generate a first set of output signals indicative of the detected light; and
a non-transitory, computer-readable medium storing instructions that, when executed by one or more processors, causes the one or more processors to determine an estimated value of a parameter of interest characterizing the one or more structures under measurement based at least in part on the first set of output signals.
